(19) United States
(12) Patent Application Publication
(10) Pub. No.: US 2015/0028600 A1
(43) Pub. Date: Jan. 29, 2015

(54) METHOD FOR LIMITING AN INRUSH CURRENT IN AN ELECTRICAL POWER CIRCUIT OF A MOTOR VEHICLE STARTER, AND CORRESPONDING ELECTRICAL CIRCUIT, CURRENT LIMITER AND STARTER

(71) Applicant: VALEO EQUIPEMENTS ELECTRIQUES MOTEUR, Creteil Cedex (FR)

(72) Inventor: Nicolas Labbe, Lyon (FR)

(21) Appl. No.: 14/383,480

(22) PCT Filed: Feb. 28, 2013
(86) PCT No.: PCT/FR2013/050411

§ 371 Date: Sep. 5, 2014

(30) Foreign Application Priority Data
Mar. 6, 2012 (FR) 12520105

(51) Int. Cl. F02N 11/08

(52) U.S. Cl. CPC F02N 11/08; F02N 2011/0881
USPC 290/38 R

(57) ABSTRACT

A method for limiting an inrush current, which is implemented in an electrical power circuit (1) of a motor vehicle starter (15). The starter includes an electromagnetic contactor (12) and an electric motor (7) comprising motor windings (6) having a rated inductance (L0). The method consists in controlling the rate of variation of the inrush current by means of an inductive element (8) inserted in series into the electrical power circuit (1). According to the invention, an initial value of the variation rate is substantially separate from the rated inductance (L0). According to another feature, the initial value is a function of a coupling coefficient between a primary winding (8) and a secondary winding (10) of a transformer (9), the primary winding (8) of which constitutes the inductive element.

### TECHNICAL FIELD OF THE INVENTION

In general, the invention relates to the field of thermal engine starters in motor vehicles. More particularly, the invention relates to a method for limiting an inrush current in an electric power circuit of a starter, as well as the corresponding electric circuit. It also relates to a current limiter which can be inserted in this electric circuit, and a starter comprising a current limiter of this type.

### TECHNOLOGICAL BACKGROUND OF THE INVENTION

When a starter is switched on in order to ensure the starting of the thermal engine of the vehicle, a substantial inrush current is created, which is close to the short-circuit current level of the starter, i.e. a current of approximately 1000 Amps. The intensity of this current then decreases as the speed of the armature of the starter, corresponding to the rotor of the machine, increases.

A consequent drop in the voltage at the terminals of the battery corresponds to this initial current spike. Other less substantial voltage drops then occur during the starting phase, and correspond to passages through successive top dead centres of the thermal engine.

The development of so-called “reinforced” starters, designed for automatic stopping/restarting systems of the thermal engine (systems known as “stop/start” or “stop and go”) nowadays impose new constraints on motor vehicle component suppliers relating to compliance with minimum voltage thresholds of the battery during the current requirement when the starter is switched on. Thus, in their specifications, motor vehicle manufacturers define a first voltage threshold which is habitually between 7 and 9 Volts, below which the battery voltage must not drop. For the following voltage drops, corresponding to the top dead centres of the thermal engine, the battery voltage must remain higher than a second voltage threshold which is habitually between 8 and 9 Volts. During the starting of the thermal engine, the voltage of the on-board network of the vehicle thus remains at a value which is sufficient to guarantee the expected functioning of the vehicle equipment.

The reinforced starters generally have power which is greater than the conventional starters, so as to obtain rapid starting for greater comfort of the users. This results in a higher inrush current during switching on, and therefore a first battery voltage drop which goes beyond the habitual values, and in relation to high demands. This gives rise to a genuine difficulty for the designer, since, in order to go above the battery voltage, it would be necessary for the starter to have internal voltage drops so great that there would then no longer be the power necessary to drive the thermal engine at a sufficient speed at a low temperature.

In the prior art, solutions have been proposed to the above-described problem. A first known solution by the inventive body is based on the use of voltage-increasing electronic converters, in order to avoid an excessively low voltage level on the on-board network. A major disadvantage of these converters consists in the substantial costs which they introduce.

Another known solution proposes controlling the starter by means of two relays, a timer, and a current-limiting resistor. In a first functioning phase, the duration of which is determined by the timer, an additional resistance is inserted in series in the electric power circuit of the starter, and limits the initial current spike. In a second functioning phase, the additional resistance is eliminated from the power circuit, in order to permit the passage of a sufficient current into the armature of the starter, and to permit an increase in the speed of the starter.

Documents EP2080897A2 and EP2128426A2 describe a starter of the aforementioned type. In addition to the additional cost involved in the extra control relay, the timer and the current limiting resistor, the introduction of this extra relay, which comprises mobile mechanical parts subjected to wear, has a negative impact on the resistance of the starter in terms of the number of starting cycles which it must be able to withstand without any problems. The resistance of the starter in terms of the number of starting cycles is a particularly stringent constraint for starters which are designed for stop/start systems. In fact, starters of this type are required to withstand approximately 300,000 starting cycles, i.e. 10 times more than the approximately 30,000 cycles required from the conventional starters.

In addition to the above-described disadvantages, the use of this second solution according to the prior art can prove unsuitable when compliance with a voltage range which is restrictive in terms of time is required by the motor vehicle manufacturer. A range of this type generally comprises a low voltage level, corresponding to the first voltage threshold indicated above, and a high voltage level corresponding to the second voltage threshold. A rising voltage gradient is also included in the range, between the low level and the high level.

Tests carried out by the inventive body, with the usual values of the manufacturers for the duration of the low level and the slope of the gradient of the range, show the difficulty which exists with this second solution according to the prior art, of remaining within the range. In fact, it has been found that there is a risk of going beyond the range at the level of its voltage gradient, when the battery voltage, after having been rectified once the initial current spike has been absorbed, drops once more at the end of the timing, with the current which passes through the armature of the starter then increasing substantially as a result of the elimination of the current-limitation resistance of the electric power circuit. After going beyond this point, the battery voltage can remain below the range for a certain period of time, and return within the range only after the end of the rising voltage gradient, whereas the instant of the start of the high voltage level has already been reached.

It has also been proposed to inserted in series in the electric power circuit of the starter a stop coil (also known as a “impact” coil) as a current-limiting element instead of a resistor, or to connect a capacitor in parallel on the starter.

These last two solutions have been implemented, alternatively or in combination, in the electric starter circuits described in document U.S. Pat. No. 6,598,574B2.

The object of this impact coil or this capacitor is to limit a speed of variation of the current in the circuit.

The effect of these elements in an electric circuit is well known by electricians, and the elements have been used for long time for this purpose in many fields, including that of motor vehicles, as shown in document U.S. Pat. No. 1,179,407.

A disadvantage of this solution is that the speed of variation of the current depends on total resistance of the circuit, and not only on additional inductance or on a capacitor. It is therefore difficult to create an accurate range corresponding to specifications of the motor vehicle manufacturers.

In addition, the electromagnetic energy which has accumulated in the impact coil will be restored at the moment when the circuit is opened, and added to the energy stored in the windings of the electric motor, which will give rise to excess voltage.

For the purpose of eliminating the aforementioned disadvantages, the inventive body has already proposed improvements to the starters which exist in the prior art, in particular for applications, in motor vehicles, of the automatic stopping/restarting function of the thermal engine.

In general, these improvements have consisted of fitting a filtering device of an inductive type in series with the electric motor in the electric power circuit of the starter, such as to limit the inrush current, and prevent a battery voltage drop after the electric motor is put into service.

New theoretical studies carried out by the inventive body have made it possible to specify the field of these improvements.

### GENERAL DESCRIPTION OF THE INVENTION

The present invention thus relates to a method for limiting an inrush current in an electric power circuit of a motor vehicle starter.

According to a first aspect, the method for limiting an inrush current in an electric power circuit of a motor vehicle starter, with the starter comprising an electromagnetic contactor and an electric motor comprising motor windings with nominal inductance, is of the type consisting of controlling the speed of variation of the inrush current by means of an inductive element inserted in series in the circuit.

According to the invention, an initial value of the speed of variation is substantially independent from the nominal inductance, and the initial value depends on a coupling coefficient which is close to one out of a primary winding and a secondary winding of a transformer, the primary winding of which constitutes the inductive element.

This initial value also highly advantageously depends on a coefficient of coupling between a primary winding and a secondary winding of a transformer, the primary winding of which constitutes the inductive element of the circuit.

Advantage is also derived from the fact that this initial value is inversely proportional to a coefficient of dispersion of this transformer.

In the method according to the invention, limitation of the inrush current advantageously depends on a secondary resistance of the secondary winding of the transformer.

This method is advantageously implemented in an electric power circuit of a motor vehicle starter, of the type comprising an inductive element in series, and the starter of which comprises an electric motor and an electromagnetic contactor.

According to the invention, the electric power circuit is distinguished in that this inductive element consists of a primary winding of a transformer, a secondary winding of which is short-circuited.

In a first embodiment of this electric power circuit, the primary winding is preferably inserted between a positive terminal of a battery of the vehicle and a power contact of the electromagnetic contactor.

In a second embodiment, the primary winding is alternatively preferably inserted between a power contact of the electromagnetic contactor and the electric motor.

A current limiter which can be incorporated in an electric power circuit of a starter of a motor vehicle according to the invention is distinguished in that it consists of a transformer with a coefficient of dispersion which is predetermined according to a voltage range of an on-board electrical network of this vehicle.

In addition, this transformer comprises a secondary winding which advantageously, alternatively or simultaneously, has a secondary resistance which is predetermined according to this voltage range.

The invention also relates to a motor vehicle starter, which is distinguished in that it comprises a current limiter with the above characteristics, this current limiter being secured on an outer housing of the starter.

These few essential specifications will have made apparent to persons skilled in the art the additional advantages obtained by taking into account the results of the theoretical studies carried out by the applicant company concerning its filtering device of an inductive type.

The detailed specifications of the invention are provided in the description which follows, in association with the appended drawings. It should be noted that these drawings serve the purpose simply of illustrating the text of the description, and do not constitute in any way a limitation of the scope of the invention.

### BRIEF DESCRIPTION OF THE DRAWINGS

FIG. 1 is a simplified process diagram known in the prior art, of an electric power circuit of a motor vehicle starter comprising a stop coil.

FIGS. 2a and 2b show the temporal development of an inrush current in electric power circuits of motor vehicle starters known in the prior art, i.e. respectively an electric motor which is blocked and an electric motor which is in free rotation.

FIG. 3 is a simplified process diagram of an electric power circuit of a motor vehicle starter comprising an inductive element according to the invention.

FIGS. 4a and 4b show the temporal development of an inrush current in electric power circuits of motor vehicle starters comprising an inductive element according to the invention, i.e. respectively an electric motor which is blocked and an electric motor which is in free rotation, in comparison with a circuit without an additional inductive element.

FIGS. 5a and 5b are schematic representations of an electric power circuit of a motor vehicle starter and its control according to two preferred embodiments of the invention.

### DESCRIPTION OF PREFERRED EMBODIMENTS OF THE INVENTION

The different elements which constitute an electric power circuit 1 of a motor vehicle starter known in the prior art are represented schematically in FIG. 1 by:
a direct source of voltage 2 with a nominal voltage U₀ which represents the on-board battery;
a switch 3 which represents an electromagnetic contactor;
a resistive element 4 which represents all the resistances of the circuit with an equivalent resistance R;
an impact coil 5 with a filtering inductance L_{F};
an induction coil 6 representing all the windings of the motor 7, and having a nominal inductance L₀;
a direct current motor 7 with a with an electromotive force of rotation E(Ω) which depends on a speed of rotation Ω.

An instantaneous intensity of the current which circulates in the circuit is known as i(t) and an instantaneous voltage at the terminals of the resistive element 4, of the impact coil 5, and of the motor windings 6 in series, is known as U(t).

For the purposes of a first accurate electrical analysis of the circuit produced by the inventive body, a sum of the nominal inductance L₀ and of the filtering inductance L_{F} is known as L.

An electromotive force constant is known as K_{E}, a coupling constant is known as K_{C}, and inertia moment of the parts in rotation is known as J, a motor couple is known as C, and an inductive flow is known as Φ.

This first electrical analysis is summarised below:

U=L·di/dt+R·i, (1)

where i−0 at t=0
(generalised Ohm's law applied to the entire circuit)

i(t)=U₀/R·(1−exp(−R·t/L)) (2)

(differential equation solution (1) without electromotive force of rotation E(Ω), the rotor being blocked, with U=U₀)

i(t)=U/R·(1−exp(−R·t/L)) (3)

(solution approximating (1) with electromotive force of rotation E(Ω), with the rotor free to rotate, with

U=U₀−E(Ω),

E(Ω)=K_{E}·Φ·Ω,

and

J·dΩ/dt=C(i)=K_{C}·Φ·i,

such that

Ω=K_{C}·Φ·i·t/J)

τ=L/R, di/dt=U₀/L (4)

at t=0, and i→U₀/R when t→∞
(extensions of (2) and (1) without electromotive magnetic force of rotation E(Ω): nominal electric time constant τ, gradient of the signal i(t) at the origin, and asymptotic level of i)

τ=L/R, di/dt=U₀/L (5)

at t=0, and di/dt=(0(i=iₘₐₓ) for U₀−E(Ω)=R·i
(extensions of (3) and (1) with electromotive magnetic force of rotation: nominal electric time constant τ, gradient of the signal i(t) at the origin, and condition of waiting for the maximum level of i)

Wₘₐₓ=½·L_{F}·i²+½·i·Φ=½·L·i² (6)

(the energy W_{mag} stored in magnetic form in the cases (1) and (2) will be restored when the circuit is opened, which will give rise to an excess voltage with amplitude proportional to L).

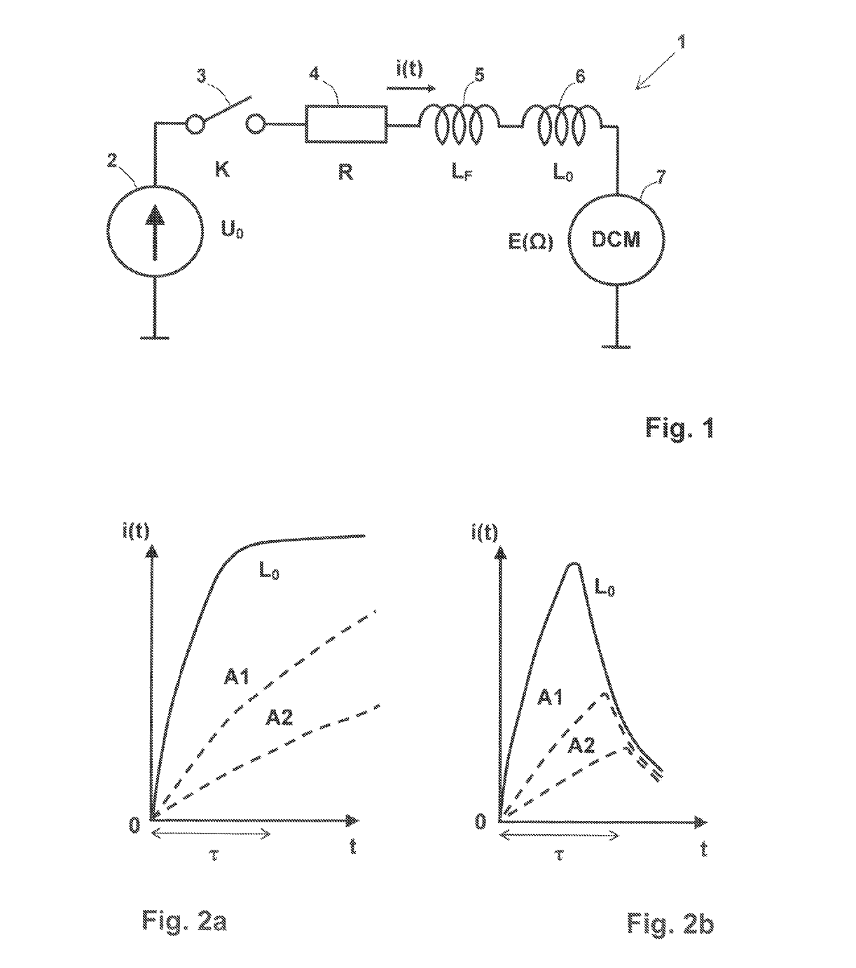

Solutions (2) for the differential equation (1) corresponding to the case when the rotor is blocked are represented in FIG. 2a, when a value of L goes from L₀ (no impact coil 5 in the circuit 1), to a value five times higher A1, or 10 times higher A2.

A higher value of L makes it possible to obtain a lower initial gradient di/dt=U₀/L, but has the disadvantage of giving rise to an increase in the magnetic energy stored W_{mag}=½·Li² in the same equation.

The instantaneous intensity i(t) of the inrush current tenants towards U₀/R for instants longer than the nominal electrical time constant τ, i.e. towards the limit which depends on all the resistances R of the electric power circuit 1, and is therefore as a result which is not easy to regulate.

Solutions (3) of the differential equation (1) corresponding to the case in which the rotor is free to rotate are represented in FIG. 2b when the value of L goes from L₀ (no impact coil 5 in the circuit 1), to the value five times higher A1, or ten times higher A2.

The control of the initial gradient di/dt by means of the increase in the value of L has the same disadvantage as the increase in the magnetic energy stored W_{mag} in the previous case.

A maximum value iₘₐₓ of the instantaneous intensity also depends in this case on external conditions which cannot be regulated, as shown in the above equations (5).

In fact, this maximum value iₘₐₓ depends on the electromotive force of rotation E(Ω) of the motor 7, which depends on the product of the characteristic parameters of the motor 7 (electromotive force constant K_{E}, couple constant K_{C} and inductive flow Φ).

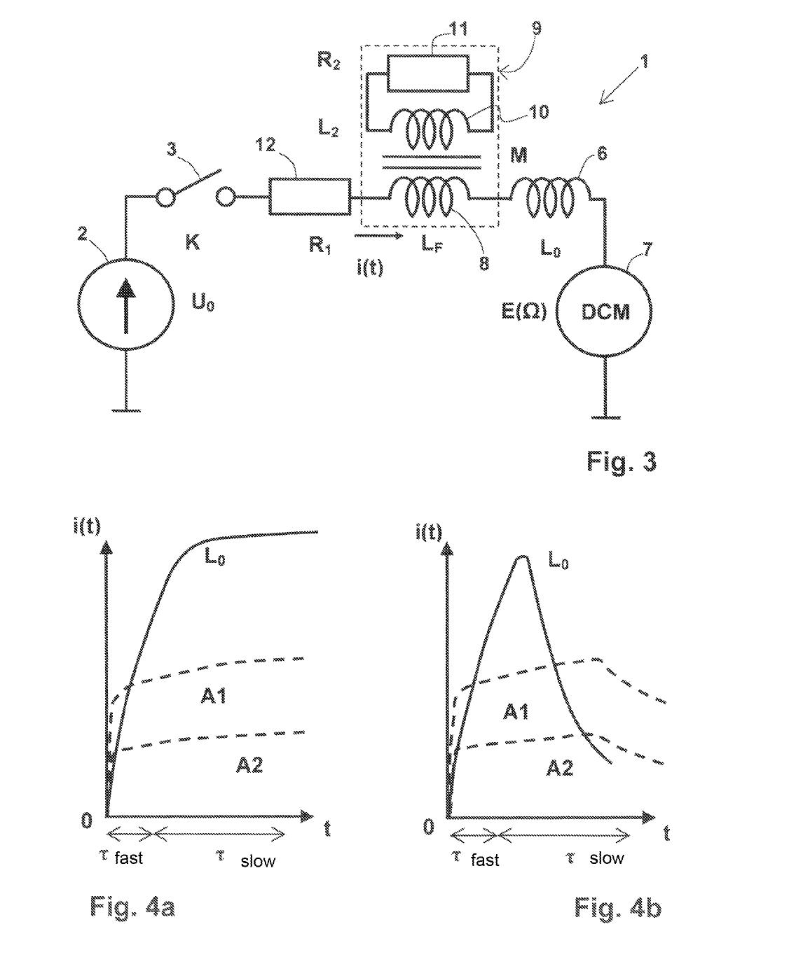

In the method for limiting an inrush current according to the invention, an initial value of the speed of variation of an inrush current and limitation of this inrush current can on the other hand be regulated independently from these external conditions, as will be shown hereinafter in association with FIG. 3.

The electric power circuit 1 which can implement the method according to the invention, shown schematically in FIG. 3, comprises in series an inductive element 8 which makes it possible to:
make the initial establishment of the inrush current as rapid as required, independently from the other components of the circuit 1;
make subsequent establishment of the inrush current as slow as required;
not contribute towards storing extra magnetic energy; and
thus regulate the limitation of the inrush current.

This inductive element 8 consists of a primary winding 8 of a transformer 9, a secondary winding 10 of which is short-circuited on its own resistor 11.

The other components represented in FIG. 3 are identical to, or analogous with, those in FIG. 1:
the source of direct voltage 2 having a nominal voltage U₀ which represents the on-board battery;
the switch 3 which represents an electromagnetic contactor;
a resistor 12 representing all the resistances of the circuit, including the primary resistance of the primary winding 8 of the transformer 9, and having total resistance R1;
the induction coil 6 representing all the windings of the motor 7, and having the nominal inductance L₀;
the direct current motor 7 having the electromotive force of rotation E(Ω) which depends on the speed of rotation Ω.

The transformer 9 is a good quality transformer, i.e. it is selected such as to have a coefficient of magnetic coupling k close to a unit.

It should be remembered that the coefficient of coupling of a transformer is defined by the ratio k=M/(L₁·L₂)^{1/2}, where L₁ is the primary inductance, L₂ is the secondary inductance, and M is a mutual inductance. The coefficient of dispersion of a transformer is defined by the quantity σ=1−k².

For the purpose of a second accurate electrical analysis of this circuit produced by the inventive body, it is considered that L₁ is a sum of the nominal inductance L₀ and of the filtering inductance L_{F} of the primary winding 8 of the transformer 9.

Thus, L₀ appears as a leakage inductance of the transformer 9 returned to the primary, and simplification of calculation is permissible provided that a lower coefficient of coupling k is taken into consideration.

In other words, M is substantially equal to 0.9 (L₁·L₂)^{1/2} if M_{F} is substantially equal to 1.0 (L_{F}·L₂)^{1/2}.

A first intensity of the inrush current which circulates in the electric power circuit 1 is known as iᵢ(t), and the instantaneous voltage at the terminals of the resistor 12, the primary winding 8 and the motor windings in series 6 is known as U(t).

A second intensity of a secondary current which circulates in the secondary winding 10 of the transformer 9 is known as i₂(t).

The electromotive force constant is known as K_{E}, the couple constant is known as K_{C}, the moment of inertia of the parts in rotation is known as J, the motor couple is known as C, the inductive flow is known as Φ, the totalised magnetic flows through the primary and secondary windings 8, 10 are known respectively as Φ₁ and Φ₂, the additional magnetic energy stored in the transformer 9 is known as W_{mag.add}, and that which is stored in the motor windings is known as W_{mag}.

This second electrical analysis is summarised below, in the knowledge that it is situated in the context of linear functioning, i.e. without magnetic saturation:

U=L₁·di₁/dt+M·di₂/dt+R₁·i₁,

where i₁=0 at t=0

0=L2·di₂/dt+M·di₁/dt+R₂·i₂, (1′)

where i₂=0 at t=0
(generalised Ohm's law applied to the two coupled electric circuits)

i₁(t)=U₀/R₁·(1−exp(−t/τ_{rapid})·B_{rapid}−exp(−t/τ_{slow})·B_{slow}),

where

### (B_{rapid}+B_{slow})=1

i₂(t)=U₀/R₂·(0−exp(−t/τ_{rapid})·C_{rapid}−exp(−t/τ_{slow})·C_{slow}), (2′)

where C_{rapid} and C_{slow} are not explained here

B_{rapid}=½·(A^{1/2}+R₁·L₂−R₂·L₁)·A^{-1/2}

B_{slow}=½·(A^{1/2}−R₁·L₂+R₂·L₁)·A^{-1/2}

τ_{rapid}=2·(L₁·L₂−M²)/(R₁·L₂+R₂+L₁+A^{1/2})

τ_{slow}=2·(L₁·L₂−M²)/(R₁·L₂+R₂·L₁−A^{1/2})

where

A=(R₁·R₂)²·(L₁/R₁−L₂/R₂)²+4·R₁·R₂·M²

(solution of the differential system (1′) without electromotive force of rotation, rotor blocked, with U=U₀)
same as (2′) but with U=U₀−E instead of U₀
(solution approximating (1′) with electromotive force of rotation, with rotor free to rotate, with

U=U₀−E(Ω),

E(Ω)=K_{E}·Φ·Ω,

and

J·dΩ/dt=C(i)=K_{C}·Φ·i,

where

Ω=Kc·Φ·i·t/J) (3′)

τ_{rapid}, τ_{slow}, and

di₁/dt=U₀·L₂/(L₁·L₂−M²) (4′)

at t=0, and i₁→U₀/R₁ when t→∞
(extensions of (2′) and (1′) without electromotive force of rotation: electric time constants, gradient of the first intensity iᵢ(t) at the origin, and asymptotic level of i₁)
τ_{rapid}, τ_{slow}, and di₁/dt at 0: same as for case (4′),

and

di/dt=0(i₁=iₘₐₓ)

for

U₀−E(Ω)=R₁·i₁ (5′)

(extensions of (3′) and (1′) with electromotive force of rotation: electric time constants, gradient of the signal i₁(t) at the origin, and condition of waiting for the maximum level iₘₐₓ of i₁)

W_{mag.add}=½·(i₁·Φ₁=i₂·Φ₂) (6′)

The primary and secondary windings (taking into consideration that they are wound in the same direction) have currents with opposite directions passing through them, since i₁ and i₂ are respectively inductive and induced, and consequently the additional magnetic energy is virtually zero:

W_{mag.add}˜½·(i₁·Φ₁−i₁·Φ₁)˜0 if the magnetic coupling coefficient k is sufficiently close to 1 (which is the case here where Φ₁ and Φ₂ are substantially equal to a common magnetic flow provided by the product of a magnetic induction B and an iron section of a magnetic core through which the said induction passes).

The total magnetic energy W_{mag.total}=W_{mag.add}+W_{mag} is thus substantially equal to that stored in the motor windings 6, i.e. W_{mag.total}˜½·(i₁·Φ)˜½·L₀i₁² as for in the absence of any additional inductive element 8 in the power circuit (no deterioration in terms of level of risk of excess voltage on the on-board network when the electric power circuit is opened).

Solutions (2′) of the differential equation system (1′) corresponding to the case in which the rotor is blocked are represented in FIG. 4a when a value of L₁ has a value A1 which is five times higher than L₀, or another value A2 which is ten times higher.

It is found that the gradient di₁/dt at the initial instant t=0 varies little according to L₁, i.e. the initial value of the speed of variation of the inrush current in the electric power circuit 1 is substantially independent from the nominal inductance L₀ of the motor windings 6.

This initial value can be made very large, in order to permit rapid establishment of the inrush current, by using a good quality transformer, as shown by the expression di₁dt=U₀·L₂/(L₁·L₂−M²) of the initial gradient of iᵢ(t). When the coupling coefficient k tends towards 1, the mutual inductance M tends towards (L₁·L₂)^{1/2} and di₁/dt tends towards infinity.

The same expression shows that this initial value is proportional to the term 1/(1−k²), i.e. it is inversely proportional to the coefficient of dispersion σ of the transformer 9.

Study of the case in which the rotor is rotating leads to an identical result (FIG. 4b).

In both cases, a first transitory speed is governed by a first electric time constant τ_{rapid} (the expression of which is given above) which can preferably be made very much lower than the nominal electric time constant τ of the electric power circuit 1 comprising an inductive element 5 known in the prior art, if the coefficient of coupling of the transformer 9 is sufficiently close to a unit.

After this first transitory speed, a second transitory speed is governed by a second electric time constant τ_{slow} (the expression of which is given above) which, unlike the preceding speed, is advantageously made very much higher than the nominal electric time constant τ.

In this second transitory speed, the first intensity iᵢ(t) differs little from the asymptotic level of the first temporary speed, i.e. its current limitation is highly advantageously regulated by means of the secondary resistance R₂ of the secondary winding 10 of the transformer 9, before the gradient di₁/dt becomes negative under the effect of the start of rotation of the motor 7.

The role of the total resistance R₁ is limited to defining the level of final short-circuit U₀/R₁, which is identical to the value U₀/R of the electric power circuit 1 comprising an impact coil 5, but is never reached, or even approached, thanks to the electromotive force of rotation E(Ω).

In the method for limiting an inrush current according to the invention, the initial value of the speed of variation of the inrush current (di₁/dt at t=0) is therefore higher than in the methods known in the prior art, consisting of adding an impact coil 5 in the electric power circuit 1.

In addition, the limitation of the inrush current is obtained independently from the conditions external to the characteristics of the transformer 9 used, i.e. in particular independently from the electromagnetic force of rotation E(Ω) of the motor 7.

By means of the method according to the invention, this limitation of the inrush current does not take the form of a higher level of magnetic energy stored, which would lead to the appearance of substantial excess voltage on the on-board electrical network when the circuit is opened.

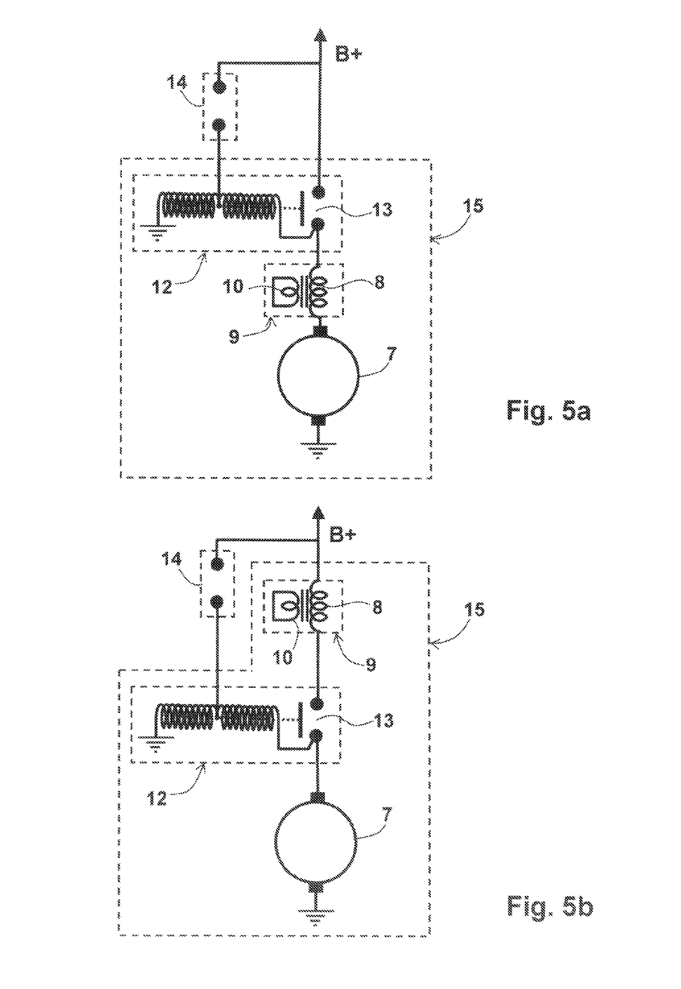

FIGS. 5a and 5b show two practical applications of the theoretical diagram presented in FIG. 3.

In these two applications, the electric power circuit 1 comprises an electromagnetic contactor 12 which is designed to supply power to the electric motor 7 from the on-board battery B+.

In a first embodiment, the primary winding 8 of the transformer 9, the secondary winding 10 of which is short-circuited, is fitted in series between the electromagnetic contactor 12 and the motor 7 (FIG. 5a).

In a second embodiment, the primary winding 8 of the transformer 9 is fitted in series between the on-board battery B+ and the electromagnetic contactor 12 (FIG. 5b).

In this case, the electromagnetic contactor 12 is a conventional starter contactor with a simple power contact 13, and comprises a solenoid formed by a pull-in coil and a hold-in coil.

The closure of a starter contact 14 of the vehicle commands the excitation of the pull-in and hold-in coils, and the activation of the motor 7 according to a sequence which is well known to persons skilled in the art, and will not be described in detail here.

The aforementioned strong initial spike of the inrush current takes place when the power contact 13 is closed, when the motor 7 is supplied with full power.

This initial spike is controlled by the transformer 9, which is preferably made in the form of a transformer of the armoured type, with windings which are coupled magnetically.

Different embodiments make it possible to optimise the primary and secondary inductances L_{F}, L₂, the mutual inductance coefficient M, and the secondary resistance R₂, according to a voltage range to be maintained on the on-board electrical network B+ at the moment of activation of the motor 7.

Typically, the primary inductance L_{F} of the transformer 9 is between approximately 0.1 and 10 mH for inrush currents with an order of greatness of 300 to 1000 Amps.

The current limiter, which is constituted by the transformer 9, is a component which is advantageously produced in the form of a cylindrical casing made of magnetic material such as steel, containing the primary 8 and secondary 10 windings.

This casing is preferably secured on the outer housing of the motor 7, in the vicinity of the electromagnetic contactor 12, in order to constitute a compact motor vehicle starter assembly 15.

It will be appreciated that the invention is not limited simply to the above-described preferred embodiments.

1. Method for limiting an inrush current in an electric power circuit (1) of a motor vehicle starter, said starter (15) comprising an electromagnetic contactor (12) and an electric motor (7) comprising motor windings (6) with a nominal inductance (L0), of the type consisting of controlling the speed of variation of said inrush current by means of an inductive element (5, 8) inserted in series in said circuit (1), wherein an initial value of said speed of variation is substantially independent from said nominal inductance (L0), and said initial value depends on a coupling coefficient which is close to one out of a primary winding (8) and a secondary winding (10) of a transformer (9), the primary winding (8) of which constitutes said inductive element.

2. Method for limiting an inrush current in an electric power circuit (1) of a motor vehicle starter according to claim 1, characterized in that said initial value is inversely proportional to a coefficient of dispersion of said transformer.

3. Method for limiting an inrush current in an electric power circuit (1) of a motor vehicle starter according to claim 1, characterized in that limitation of said inrush current depends on a secondary resistance (R2) of said secondary winding (10).

4. Electric power circuit (1) of a motor vehicle starter, said starter (15) comprising an electric motor (7) and an electromagnetic contactor (12), of the type comprising an inductive element (5, 8) in series, and which can implement the method according to claim 1, characterized in that said inductive element (5, 8) consists of a primary winding (8) of a transformer (9), a secondary winding (10) of which is short-circuited.

5. Electric power circuit (1) of a motor vehicle starter according to claim 4, characterized in that said primary winding (8) is inserted between a positive terminal (B+) of a battery of said vehicle and a power contact (13) of said electromagnetic contactor (12).

6. Electric power circuit (1) of a motor vehicle starter according to claim 4, characterized in that said primary winding (8) is inserted between a power contact (13) of said electromagnetic contactor (12) and said electric motor (7).

7. Current limiter (9) which can be incorporated in an electric power circuit (1) of a starter of a motor vehicle according to claim 4, characterized in that it consists of a transformer (9) with a coefficient of dispersion which is predetermined according to a voltage range of an on-board electrical network of said vehicle.

8. Current limiter (9) which can be incorporated in an electric power circuit (1) of a starter of a motor vehicle according to claim 4, characterized in that it consists of a transformer (9) comprising a secondary winding (10) with a secondary resistance (R2) which is predetermined according to a voltage range of an on-board electrical network of said vehicle.

9. Motor vehicle starter (15), characterized in that it comprises a current limiter (9) according to claim 7, said current limiter (9) being secured on an outer housing of said starter (15).

10. Method for limiting an inrush current in an electric power circuit (1) of a motor vehicle starter according to claim 2, characterized in that limitation of said inrush current depends on a secondary resistance (R2) of said secondary winding (10).

11. Electric power circuit (1) of a motor vehicle starter which can implement the method according to claim 2, said starter (15) comprising an electric motor (7) and an electromagnetic contactor (12), of the type comprising an inductive element (5, 8) in series, characterized in that said inductive element (5, 8) consists of a primary winding (8) of a transformer (9), a secondary winding (10) of which is short-circuited.

12. Electric power circuit (1) of a motor vehicle starter which can implement the method according to claim 3, said starter (15) comprising an electric motor (7) and an electromagnetic contactor (12), of the type comprising an inductive element (5, 8) in series, characterized in that said inductive element (5, 8) consists of a primary winding (8) of a transformer (9), a secondary winding (10) of which is short-circuited.

13. Current limiter (9) which can be incorporated in an electric power circuit (1) of a starter of a motor vehicle according to claim 5, characterized in that it consists of a transformer (9) with a coefficient of dispersion which is predetermined according to a voltage range of an on-board electrical network of said vehicle.

14. Current limiter (9) which can be incorporated in an electric power circuit (1) of a starter of a motor vehicle according to claim 6, characterized in that it consists of a transformer (9) with a coefficient of dispersion which is predetermined according to a voltage range of an on-board electrical network of said vehicle.

15. Current limiter (9) which can be incorporated in an electric power circuit (1) of a starter of a motor vehicle according to claim 5, characterized in that it consists of a transformer (9) comprising a secondary winding (10) with a secondary resistance (R2) which is predetermined according to a voltage range of an on-board electrical network of said vehicle.

16. Current limiter (9) which can be incorporated in an electric power circuit (1) of a starter of a motor vehicle according to claim 6, characterized in that it consists of a transformer (9) comprising a secondary winding (10) with a secondary resistance (R2) which is predetermined according to a voltage range of an on-board electrical network of said vehicle.

17. Motor vehicle starter (15), characterized in that it comprises a current limiter (9) according to claim 8, said current limiter (9) being secured on an outer housing of said starter (15).
